(19) United States
(12) Patent Application Publication
(10) Pub. No.: US 2026/0256553 A1
(43) Pub. Date: Sep. 3, 2026

(54) SCAN ACCESSORY SYSTEM WITH SCAN ELEMENT FOR DIGITALLY SCANNING A DENTAL SITUATION

(71) Applicant: MEDENTIKA GMBH, Hügelsheim (DE)

(72) Inventors: Bernd GADDUM, Hügelsheim (DE); Tobias LUDWIG, Hügelsheim (DE)

(73) Assignee: MEDENTIKA GMBH, Hügelsheim (DE)

(21) Appl. No.: 19/165,027

(22) PCT Filed: Mar. 6, 2024
(86) PCT No.: PCT/EP2024/055767

§ 371 Date: Sep. 12, 2025

(30) Foreign Application Priority Data
Mar. 13, 2023 (EP) 23161383.7

(51) Int. Cl. A61C 9/00

(52) U.S. Cl. CPC A61C 9/004

(57) ABSTRACT

A scan element for a digital scan and for releasable fastening to a scan post fastened in an implant or an installation region of a jaw, including a holding portion serving to be received and fastened on a scan post, the holding portion having a height in a height direction in the direction of longitudinal extent of the scan post, and a wing adjoining the holding portion and extending at an angle of 55° to 125° with respect to the height alignment of the holding portion, wherein the wing at least sectionally has such a unique contour that two adjacent scanned.

The present invention relates to a scan element for a digital scan and for releasable fastening to a scan post fastened in an implant, an abutment, or in an installation region of a jaw, as well as a scan accessory system for digitally scanning a dental situation with a scan element and a scan post. The invention further relates to a method for using the scan accessory system.

To capture a situation in the oral cavity, in particular the tooth position or the position of implants in a dental arch, conventional methods in the prior art classically involve creating impressions with an impression tray. This is very un-pleasant for the patient. Therefore, in more recent times, digital scans of the dental arch of the mandible or maxilla are made.

If only individual teeth in a dental arch are replaced, a digital scan is generally unproblematic. An implant is placed in the position of the missing tooth, into which a scan post (also called scan body) is inserted for a scan in order to detect the position and orientation of the implant.

However, if a large number of teeth in a patient are to be replaced by a bridge or a full denture, these are fixed to the jawbone with a few implants. With a full denture, for example, four to six or more implants are placed in the entire jaw. To capture the position of the implants and the oral situation of the corresponding jaw, a digital scan is performed. The scan posts are inserted into the implants to mark their position and orientation.

Problematic factors arise during digital scanning in the oral cavity, including the large distance between the scan posts and the reflective surface of the gingiva due to saliva. The shape of the edentulous gingiva portions, which is a sequence of curves, is often inaccurately captured, and the precise alignment of the images is difficult. The need to scan long distances where only gingiva is present when there is a large gap also leads to reflections from moisture and saliva in the mouth, which causes interruptions and displacement in the scan images (so-called “stitching errors”). This impairs the accurate determination of the overall situation from the individual scan images. Consequently, a greater distance between the scan posts carries the risk of inaccurate assembly and thus faulty restorations.

To solve this problem, for example, US2023/0011481 A1 discloses a system consisting of several scan abutments with elongated prismatic bodies. To perform a scan, some (for example, six) of these scan abutments are fastened to existing implants in the patient's mouth so that they essentially cover the entire dental arch. To minimize and simplify the joining of the scanned data, the scan abutments are positioned close to one another, whereby it is advantageous to achieve an overlapping transition from approximately the midpoint of one scan abutment to the midpoint of the next scan abutment. In a subsequent scanning process, which can be performed with a conventional intraoral scanner, scanning is first performed from one end of the arch to the other and then back to the starting point, preferably in a zigzag path. To improve accuracy, it is recommended to perform additional scans.

Based on this, there is consequently a need to create a possibility with existing intraoral scanners or digital scanners to perform a flawless scan and to capture the oral and jaw situation exactly. There is also a need for a simple, patient-friendly solution that requires as few auxiliary elements as possible in the patient's mouth and where a single scan is sufficient for capturing the oral and jaw situation.

The present problem is solved by a scan element with the features of claim 1, by a scan accessory system with the features of claim 11, and by a method with the features of claim 16.

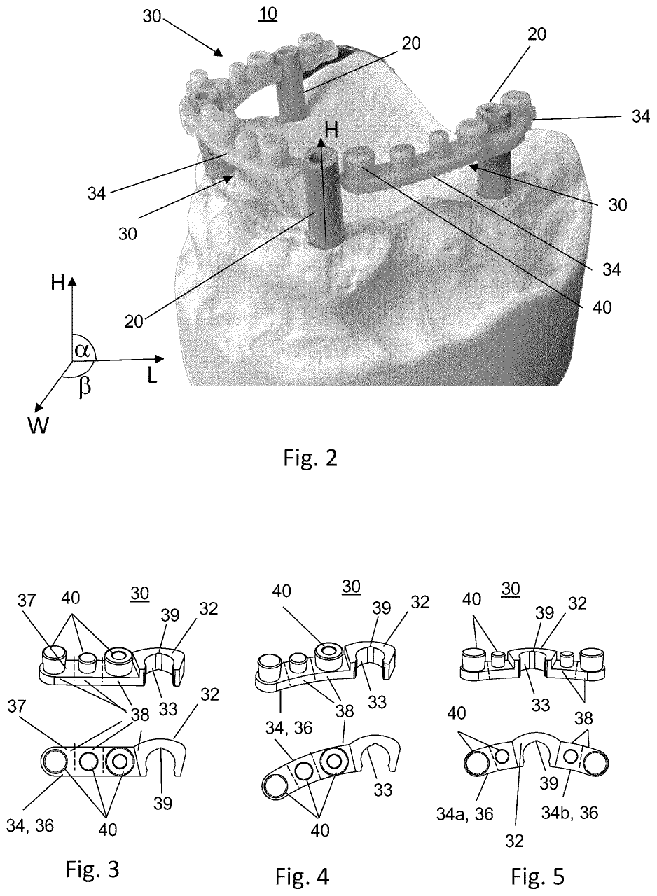

The inventive scan element, which is also called a scan wing, is used for a digital scan and is designed and suitable for releasable fastening to a scan post fastened in an implant, an abutment, or in an installation region of a jaw. For this purpose, the inventive scan element comprises a holding portion for receiving and fastening to a scan post. The holding portion of the scan element has a height in a height direction that points in the direction of the longitudinal extent of the scan post. When a Cartesian coordinate system is introduced, the longitudinal extent of the scan post extends along the H-axis, as does the height direction of the holding portion, cf. FIG. 2.

A wing adjoins the holding portion of the scan element, which has a longitudinal extent and which extends at an angle α of 10° to 170° with respect to the height direction of the holding portion. Preferably, the angle is between 55° and 125°. The angle α then spans between the longitudinal extent of the wing of the scan element and the H-axis.

The wing of the scan element has at least sectionally such a unique contour that in a digital scan two adjacent scanned portions of the wing are uniquely distinguishable and assignable. The wing of the scan element has a wing height that extends in the height direction. The wing height of the wing is preferably less than the height of the holding portion.

In practical use, the scan element is fastened to a scan post with its holding portion. A wing, which has a longitudinally extended wing body extends away from the holding portion. This makes it possible to bridge the gaps between two adjacent scan posts and to provide a structure for the digital scan that is uniquely distinguishable and assignable in its contour. By detecting the scan element and in particular the wing of the scan element, a digital scan of the overall oral situation can be produced, in which the positions and orientations of adjacent, but spaced-apart scan posts can be uniquely and flawlessly recognized and detected. This ensures that a digital image of the oral situation can be created overall to manufacture a bridge or prosthesis that can be mounted on at least two spaced-apart, but adjacent implants.

The inventive scan element, also called a scanwing, has the advantage that it leads to a very strong reduction or avoidance of stitching errors in scans with an intraoral scanner. By means of the scan element, it is possible to avoid the errors that can otherwise arise when joining the individual images into a 3D image, 3D model, or 3D volume model, which can occur when the position of two successively created scan images is not uniquely related to one another or has a displacement. With the help of the scan element, the edentulous segments in the mouth are bridged with the wing of the scan element. This provides an auxiliary orientation to the intraoral scanner. In other words: if the distance of two scan elements, an edentulous jaw area, is greater than the recording area or detection area of the intraoral scanner, the intraoral scanner is not provided with the one-to-one assignment when “assembling” the individual images (stitching error), since the gingiva surface often has very similar shapes. For this purpose, the scan element provides the necessary auxiliary orientation by bridging the edentulous jaw area. Without the inventive scan element, the scan results would be very faulty solely due to gingiva images between scan posts fastened in implants. This is because the gingiva images often have very similar round shapes and are partially covered with saliva, which leads to reflections. The individual images during the scan cannot be joined together exactly and correctly in terms of position.

The scan elements are thus auxiliary parts or accessories that are applied to already existing scan posts. The scan element can be supplied in different sizes, diameters, and shapes and is releasably connected to the scan posts.

Since the wing height of the wing of the scan element is preferably less than the height of the holding portion, a generally quite flat scan element is formed. The contour is very pleasant for the patient, since a relatively low-volume foreign body or auxiliary body must be inserted into the patient's mouth. This also results in a larger volume within the space (oral cavity) in which the intraoral scanner can be moved. The scanner can be better aligned. The generated scans and the 3D models based on them thus have a significantly higher quality.

According to a further aspect, the present invention relates to a scan accessory system for digitally scanning a dental situation or jaw situation in a patient's mouth. The scan accessory system comprises a scan post for fastening in an implant, an abutment, which is fastened to an implant for example, or in an installation region of a jaw, as well as a scan element for releasable fastening to the scan post.

The scan post has a post body extending in the longitudinal direction, which has a contact surface in a holding region for contacting the scan element. The scan element has a holding portion for receiving the scan post and for fastening to the scan post. Preferably, a connection is made between the scan element and the scan post such that the holding portion of the scan element corresponds to the holding region of the scan post and a contact with the scan element is formed on the contact surface of the holding region of the scan post.

The holding portion of the scan element is preferably designed such that the scan element can be releasably slid, clipped, or clamped onto the scan post. The sliding can be done from above or from the side if the holding portion has a corresponding recess. The recess on the inner side of the holding portion enables reliable and secure clamping of the scan element to the scan post. It can be a channel. The recess or the channel is preferably designed such that with different diameters or sizes of the scan element, the same clip or clamping force is applied from the holding portion of the scan element to the scan post in practice. Even with the same outer sizes or diameters of the holding portion, the snap or clamping force, which are each holding forces, on the scan post is thus independent of the size and contour of the scan post and is preferably always the same.

The holding portion of the scan element has a height in the height direction, which runs in the direction of the longitudinal extent (H-axis, FIG. 2) of the scan post. The longitudinal extent of the scan post is preferably generally aligned essentially vertically. A wing adjoining the holding portion of the scan element is connected or formed at an angle α of 10° to 170°, preferably 55° to 125°, to the height direction of the holding portion, so that a one-piece scan element is formed.

With an implant arranged at an angle in the jaw or a diagonally running scan post or scan body, a compensation can be created by a scan element with one or two angled wings such that the wing or wings are arranged essentially or almost horizontally and/or parallel to the jaw.

Preferably, the angle α to the height direction is between 70° and 110°, particularly preferably between 80° and 100°. Other, deviating angles or a larger angle range of, for example, 10° to 170° are also possible. In an embodiment with two wings that adjoin the holding region, the angles a for each wing can be different.

The wing has at least sectionally a unique contour that is designed such that in a digital scan two adjacent scanned portions of the wing are uniquely distinguishable and assignable. This is the prerequisite for an exact scan model or 3D model to be generated on the basis of the scan data, since the individual images of the 3D scan can be joined together seamlessly and without displacement.

The holding region of the scan post is designed such that the scan element can be fastened to the scan post or its post body at any position in the height direction. The scan element can thus be infinitely adjusted in its height in the longitudinal extent of the scan post.

This has the great advantage that the height of the scan element on the scan post is freely selectable and adjustable. On the one hand, a height (or position) of the scan element can be chosen such that the scan element has no contact with the gingiva. In this way, it is also possible to capture the gingiva during a scan. On the other hand, the position of the scan element on the scan post can be adjusted such that enough free space is created in the mouth to move the intraoral scanner comfortably and without collision. Collisions with the scan posts or the scan elements attached as auxiliary parts can thus be avoided.

A further aspect of the present invention relates to a corresponding method.

Preferred embodiments of the invention are described in the dependent claims. It is understood that the features mentioned above and those yet to be explained below can be used not only in the combination specified in each case, but also in other combinations or alone, without leaving the scope of the present invention. In particular, the method and a computer program product can be implemented in accordance with the embodiments described for the device in the dependent claims.

In a preferred embodiment of the scan element, the wing has several positioning elements on its surface or on the surface of its wing body. The positioning elements are formed in one piece with the wing body. The positioning elements are designed such that two adjacent positioning elements are different from one another and distinguishable in a scan. In this way, the respective position can be uniquely captured for each recorded digital scan image during a scan. The positioning elements are thus a good way to avoid stitching errors during scanning and to increase the quality of the scan. Adjacent positioning elements are preferably different so that individual images can be uniquely recognized and joined together during the scan.

In a preferred embodiment, at least one scanned portion of the wing comprises at least one positioning element. All scanned portions of the wing can each comprise a positioning element. Alternatively, individual or all scanned portions can have several positioning elements.

Individual or several positioning elements can have a bore, preferably a through-bore. This reduces the volume and weight of the scan element without significantly limiting its load capacity. Preferably, all positioning elements have a bore.

In a preferred embodiment, all or individual positioning elements are conically shaped, particularly preferably conically inverted, i.e., undercut or “going under”. The base of the positioning element on the wing surface has a smaller base area than the free end; for round positioning elements, a smaller diameter of the base compared to the diameter of the free end.

In a further preferred embodiment, two adjacent positioning elements are spaced apart from one another. In this way, gaps are formed in which the wing is formed by the original surface of the wing body. The positioning elements can certainly repeat in geometries at certain intervals. Two adjacent positioning elements must be different in their geometry, i.e., shape, size, and/or height.

Preferably, at least two of the positioning elements have a different height and/or a different cross-section. In particular, two adjacent positioning elements are different.

An equally preferred embodiment of the scan element has a wing whose contour changes in the direction of a free end of the wing. The wing preferably has a wing body that changes or continuously changes from the holding portion to its free end. It is possible, for example, for the wing body to taper in height and/or width in the direction of the free end. Of course, it is also possible for a taper to occur in the direction of the holding portion, but this is less preferred, as stability may suffer.

A preferred embodiment of the scan element provides that two wings (in one piece) that are preferably opposite one another adjoin the holding portion. In this way, it is possible to form scan elements that have not only one wing, but two or even more wings. Preferably, two wings lie opposite one another, with the holding portion being arranged between the two wings. In a particularly preferred embodiment, the two wings that are molded onto the holding portion enclose an angle β of 180°. It has proven to be very advantageous if the angle β between the two opposite wings is in a range between 120° and 180°. The angle β is the angle formed between the wings in a wing plane spanned by the wings; it is not the angle α to the height alignment H.

Special embodiments of the wings do not only have a wing body extending straight in the longitudinal direction. The wings can have a wide variety of shapes or variants. For example, the wing body can also have a curved shape in addition to the straight shape, preferably a shape curved in the horizontal plane. The different shapes serve to adapt to the given jaw course. Thus, curved shapes with different bending radii are possible.

It is also possible that the wings can be arranged unilaterally, bilaterally, or even multilaterally. For this reason, it has proven to be advantageous if the scan elements can be shifted in height in the longitudinal direction of the scan posts. It is thus possible, for example, to arrange two scan elements one above the other on a scan post.

The length of a wing of the scan element can preferably vary so that scan elements with wings of different lengths are formed. The lengths can range from a few millimeters to several centimeters. As a rule, with a total wing length of more than 4 cm or more than 3 cm, a scan element with two opposite wings is chosen.

In a preferred embodiment of a scan element with two wings, the two wings have the same length. It is also preferred that the wings can have different lengths. They can have the same or essentially the same width. With a suitable choice of material for the scan elements (for example, plastic), the wings can also be shortened manually before they are mounted on a scan post.

In a preferred embodiment of the scan element, it consists of a non-toxic material. The scan element is preferably formed from a material that is detectable by a digital scanner. A scan element made of plastic or metal or a composite material is preferred.

The scan element can be manufactured in different ways, for example, by printing, 3D printing, or milling. A scan element made of plastic that can be manufactured in an injection molding process is particularly preferred. Materials that are easy to scan, such as plastics that have a sufficient roughness or suitable surface, are therefore suitable.

Preferably, a scan element has such a surface that a detection of the scan element in a digital scan occurs with a negligible error rate in practical application. The material must be of such a nature or, for example, have such a roughness that it does not lead to reflections that cause errors during a digital scan. For this reason, matte plastics or matted metals are particularly suitable. In particular, the surface of the material is such that reflections of a light beam or laser beam are avoided as much as possible, preferably in a moistened state or in a wet state of the scan element.

A preferred embodiment of the one-piece scan element provides that the holding portion has an opening, preferably a lateral opening. The holding portion is preferably designed in the form of a claw, a clip, or a clamp, so that it can be particularly preferably clipped or clamped onto a scan post. Preferably, the lateral opening of the holding portion is so designed that the scan post can be received through the opening. The scan post can thus be clipped or clamped onto the scan element through the opening. The contour of the holding portion briefly yields so that the opening widens and then returns to its original shape after the scan post has passed. The width of the opening is preferably less than the diameter of the scan post. In this way, a form-fitting or friction-locking connection is formed between the scan element and the scan post.

In a preferred embodiment of a scan accessory system with a scan element and a scan post, the scan element can be arranged on the scan post, especially when the scan post is fastened in a patient's mouth, so that the scan element is spaced from the patient's gingiva. Preferably, the distance to the gingiva is so large that not only the scan element but also the ginviva below the scan element can be captured during a digital scan.

In a preferred embodiment of the scan accessory system, the scan element can be fastened to the scan post such that the scan element can be rotated around the scan post, i.e., around the longitudinal alignment of the scan post or H-axis of the aforementioned coordinate system. It can thus be turned or pivoted in its angular position around the scan post. Preferably, pivoting or rotation at an angle of at least 90° is enabled. Furthermore, the scan accessory system preferably allows pivoting of the scan element on the scan post by at least 135°, more preferably by at least 180°. In an also preferred embodiment, pivoting of the scan element around the scan post by at least 270° is possible. In this way, the scan element can be adapted in its positioning relative to the scan post to the current oral situation of a patient.

A further adaptation to current oral situations can be made by using scan elements with different wings, for example, with different lengths or different longitudinal extents of the wing bodies.

A further preferred embodiment of the scan accessory system is so designed that when several scan posts are placed, for example in a patient's mouth, at least one of the scan posts carries a scan element. To enable reliable scanning within the mouth, the scan element of one of the scan posts is aligned such that it is connected to one of the other scan posts. This involves a contact of the wing body of the scan element with an adjacent scan post to which the scan element is not fastened, clipped, or clamped. The connection to the adjacent scan post can preferably be fixed by gluing. Adhesives suitable for the dental field can be used, which can, for example, also be cured by the use of ultraviolet light.

In a preferred embodiment of the scan accessory system, the body of the scan post is partially, preferably essentially completely, rotationally symmetrical. Alternatively or additionally, the body of the scan post can have a recess that extends at least partially along the body in the longitudinal direction, wherein the recess is preferably planar. This flattening of a partial area of the scan post can serve as an orientation of the scan post in the implant or on an abutment fastened in the implant.

The invention is described and explained in more detail below with the aid of a few selected exemplary embodiments in connection with the accompanying drawings. They show:

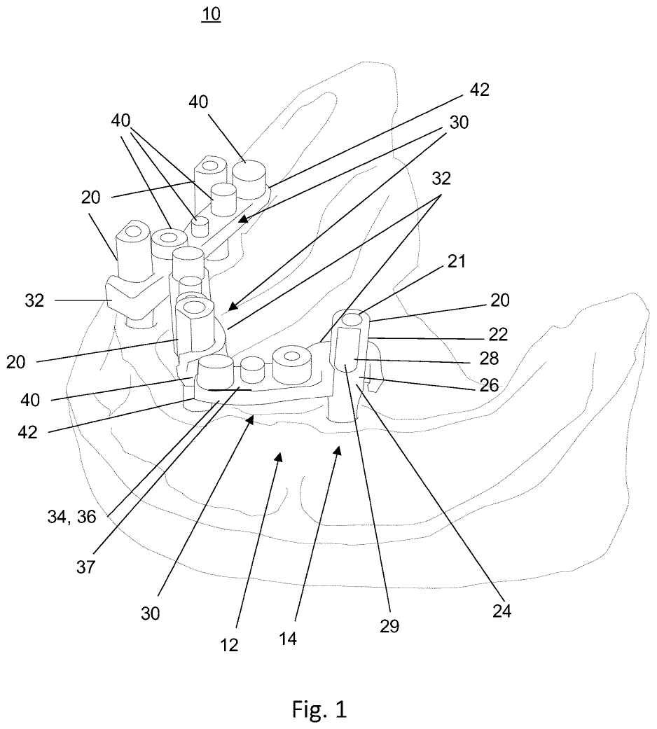

FIG. 1 a jaw model with a scan accessory system comprising a scan element and a scan post;

FIG. 2 a jaw model with a scan accessory system;

FIG. 3 a scan element with a straight wing body;

FIG. 4 a scan element with a curved wing body;

FIG. 5 a scan element with two short wings;

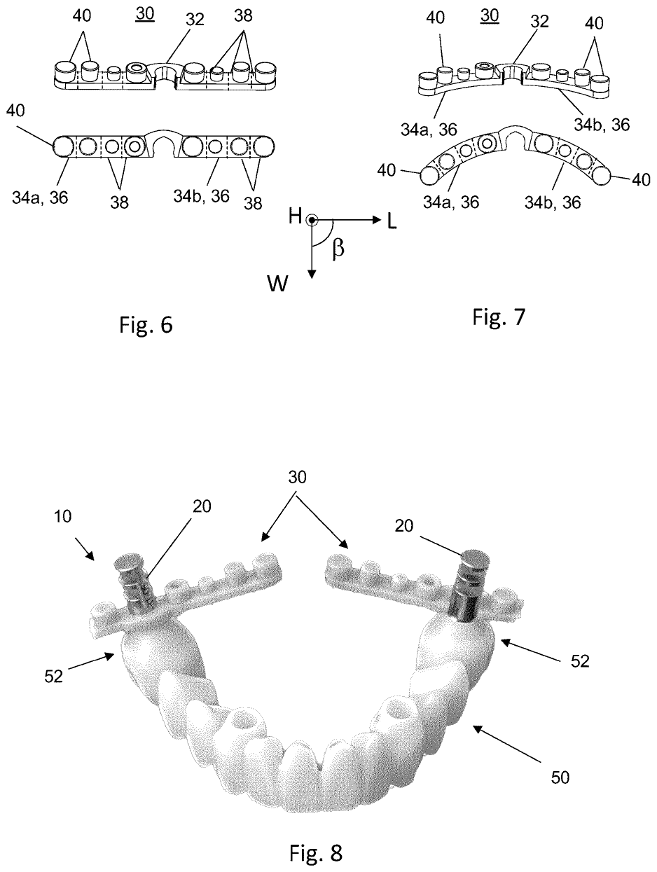

FIG. 6 a scan element with two straight wings;

FIG. 7 a scan element with two curved wings;

FIG. 8 a schematic representation of a manufactured prosthesis with a scan element and a scan post; and

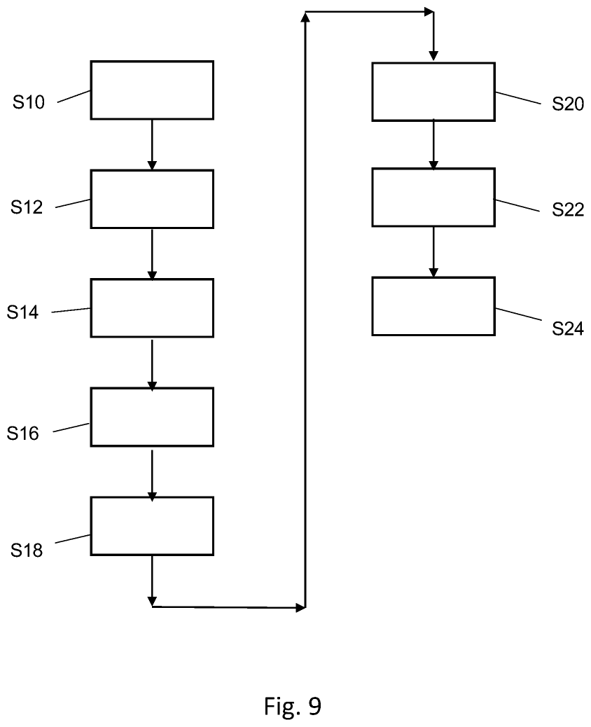

FIG. 9 a schematic drawing of a flowchart of the inventive method.

FIG. 1 shows an exemplary model of a jaw 12 with an inventive scan accessory system 10, which comprises several scan posts 20 and several one-piece scan elements 30. The scan accessory system 10 is arranged in the model of the jaw 12, with the scan posts 20 being positioned in an installation region 14 of the jaw. The scan posts are fastened in implants (not shown) in the jaw 12.

The scan posts 20 comprise a post body 22 with a holding region 24 for receiving and holding the scan element 30. The holding region 24 has a contact surface 26 that comes into contact with the scan element 30 or a holding portion 32 of the scan element.

In the preferred embodiment shown here, the post body 22 comprises a recess 28 in the form of a planar post surface 29, which has proven to be advantageous for a digital scan in order to uniquely and easily detect the position and orientation of the scan post 20 in the mouth and in the jaw.

For fastening the scan post 20 to the implant (not shown) in the installation region 14, the scan post 20 has a bore 21 (through-bore) that extends in the longitudinal direction of the scan post. By means of a screw (not shown) that extends through the bore 21 of the scan post 20, the scan post 20 can be screwed into the implant.

The scan elements 30 shown here have a holding portion 32, with which the scan element 30 is fastened to the scan post 20, as well as a wing 34 with a wing body 36. The wing body 36 extends away from the holding portion 32 and has several scan sections 38. The wing body 36 has several positioning elements 40 on its surface 37. The positioning elements 40 are preferably spaced apart from one another. They are designed such that two adjacent positioning elements 40 have different shapes, different heights, and/or different diameters. Thus, two adjacent positioning elements 40 are clearly distinguishable from one another; the same applies to the two corresponding, adjacent scan sections 38.

It can be seen from FIG. 1 that the scan accessory system 10 comprises four scan posts 20 and three scan elements 30. The scan elements 30 are aligned such that they are aligned in the direction of the adjacent scan post 20, so that a scan element 30 preferably touches the adjacent scan post or the adjacent scan element 30 arranged on the adjacent scan post 20. The longitudinal direction of the scan elements thus points in the direction of the adjacent scan post 20. Due to the alignment of the scan elements 30, the distance and gap between two adjacent scan posts 20 are bridged, so that during a digital scan, the oral region can be scanned and uniquely recognized and identified due to the presence of the scan accessory system 10.

The scan elements 30 are preferably aligned such that they are in contact with the adjacent scan post 20 or with the scan elements 30 arranged on the adjacent scan post 20. In order to create a stable overall arrangement, the free ends 42 of the scan elements 30 can be fixed to the adjacent scan element, for example, at a free end 42, for example, by gluing them together.

The positioning elements 40 are preferably conical such that their base, which is connected to the wing body 36 of the wing 34, has a smaller base area than the free end. Such a shape is advantageous in a so-called “interlocking” of several scan elements 30 and scan posts 20 with one another. When glued, the adhesive is cured so that a connecting element is formed that connects two adjacent scan elements. Due to the “inverted conical” shape of the positioning elements 40, the scan elements 30 cannot slip downwards when the entire scan accessory system 10 is removed. This becomes possible when the scan posts 20 have been detached from the implants or abutments.

The interlocking of the scan elements 30 with one another or on the scan post 20 serves, on the one hand, to prevent the patient or practitioner from changing the scan element position during the scanning process. On the other hand, the interlocked overall situation of the scan accessory system 10 can be used as a control key for a later model made from the scan.

In order to enable easy alignment of the scan elements 30, it is advantageous if the scan post 20 is designed to be at least partially rotationally symmetrical, at least in the area of the holding region 24, and the holding portion 32 of the scan element 30 is designed in the form of a corresponding opening, recess, or a collar. The holding portion 32 can also be clamp-like.

In FIG. 1, it can be seen that the scan elements 30 are each arranged on the scan posts 20 such that the scan elements 30 are spaced from the jaw 12 and the gingiva. In this way, the scan elements 30 preferably do not rest on the gingiva, so that the gingiva located under the scan element 30 can also be captured by means of the digital scan. The scan element 30 thus provides an optical guide for the digital scanner, so that the individual scanned images, which usually consist of several layers or recordings (scans), can be joined together seamlessly and without displacement or errors later. In this way, a flawless 3D image or 3D model of the oral situation and/or the jaw 12 can be generated.

FIG. 2 shows a jaw model with the scan accessory system 10, which comprises four scan posts 20 that are spaced apart from one another. Scan elements 30 are attached to three of the four scan posts 20, in the present case clamped or clipped on. The scan elements 30 each have two wings 34 of different lengths. The scan elements 30 bridge the distances formed between the scan posts 20, so that a precise scan of the entire model situation can be performed.

FIG. 3 shows an embodiment of a scan element 30, as used, for example, in FIG. 1. The scan element 30 has a holding portion 32 and an adjoining wing 34 with a wing body 36. The wing has several scan sections 38, in the embodiment shown, three scan sections 38. In each scan section, the wing body 36 has a positioning element 40, each of which is arranged on the surface 37 of the wing body 36. The positioning elements 40 have different contours. They are essentially cylindrical. Other shapes are also possible. Preferably, as shown in FIG. 3, at least one of the positioning elements 40 has a bore. If necessary, the scan element 30 can be secured with a thread in order to prevent the patient from swallowing the scan element 30. The positioning elements 40 with a bore also reduce the total volume and weight of the scan element 30 as well as the use of material and reduce the shrinkage of the positioning element 40 during the injection molding process.

FIG. 3 shows that the wing body 36 of the wing 34 is straight and adjoins the holding portion 32 directly.

The holding portion 32 is claw-shaped and has a lateral opening, so that the scan element can be clipped or clamped onto a scan post 20. The inside 33 of the holding portion 32 is preferably smooth and not arched, i.e., flat. Therefore, the scan element 30 can be adjusted to any height on a corresponding scan post 20, as long as the contact surface 26 of such a scan post 20 is also flat.

A holding portion 32 preferably has an optional recess that extends in the height direction, e.g., in the form of a slit or a flat channel 39. This makes it easier to fasten and move the scan element 30 on the scan post 20 and, if necessary, also to easily release it by means of an engaging tool. The channel 39 preferably enables a holding force of the scan element 30 that is independent of the contour of the scan post 20.

FIG. 4 shows a scan element 30 that differs from the scan element according to FIG. 3 in that the wing 34 is slightly curved. The wing body 36 of the scan wing has a slight curve in the horizontal plane, if necessary in the plane spanned by the wing (L-W plane), so that the underside of the scan element 30 and thus the underside of the wing body 36 is flat. As shown here, the underside of the wing body 36 is preferably flush with the underside of the holding portion 32, i.e., it runs in a straight line.

While FIGS. 3 and 4 show a scan element with a holding portion 32 and a single wing 34, FIG. 5 shows a scan element with two wings 34a, 34b, which are molded onto different, preferably opposite sides of the holding portion 32.

In contrast to the embodiments according to FIGS. 3 and 4, the wing body 36 is shortened in the embodiment according to FIG. 5. It has two scan sections 38 on each wing 34, each with a positioning element 40. The two positioning elements are designed differently, so that they are clearly distinguishable from one another. Of course, the individual wings 34 can be longer and have more than two scan sections 38 and/or positioning elements 40.

The two wings 34a, 34b according to FIG. 5 are arranged on the holding portion 32 such that they have an angle β to one another that is different from 180°. The angle β is about 160°.

FIG. 6, on the other hand, shows a scan element 30 with two straight wings 34a, 34b. The two wings 34 each have an elongated straight wing body 36. However, the wings 34 are arranged so that they enclose an angle β of 180°. Both wings 34 thus extend in opposite directions away from the holding portion 32. Other angles than 180° are also possible in various embodiments.

The wings 34 with wing bodies 36 shown here are significantly longer than the wings shown as examples in FIGS. 3 to 5 and have a total of four scan sections 38 each. Each scan section 38 comprises a positioning element 40. Several positioning elements 40 per scan section 38 are fundamentally possible for all scan elements 30.

The positioning elements 40 are designed such that two adjacent positioning elements 40 are different. However, non-adjacent positioning elements can be the same. This can be seen in the exemplary embodiment shown in FIG. 6: the positioning element 40 arranged closest to the holding portion 32 on the right wing 34b has the same shape as the positioning element 40 at the free end of the wing. However, two directly adjacent positioning elements 40 should be distinguishable from one another in order to increase scanning accuracy, which is the case in the present embodiment.

FIG. 7 shows an embodiment of a scan element 30 with two wings 34a, 34b, which each have a curved wing body and together form a curved scan element.

FIG. 8 shows a prosthesis 50 with a scan accessory system 10 that consists of two scan posts 20 and two scan elements 30. The prosthesis 50 is essentially U-shaped and manufactured on the basis of data captured during an intraoral scan. The scan accessory system 10 is used here to detect possible deviations during a check of the prosthesis by means of a scan. Even with such a scan, the two free prosthesis ends 52 of the U-shaped prosthesis 50 are difficult for a scanner to detect, since they are too far apart. Due to the lack of a connection between the two free ends, there may be deviations when joining the individual scan images. The scan accessory system with scan post and scan element forms a connecting element and reduces the distance between scan-able elements in order to make a verification scan more reliable.

In addition, the scan of the prosthesis 50 with the scan accessory system 10 enables a precise spatial assignment of an opposing jaw to the scanned jaw with the help of the prosthesis 50 and simultaneous transfer of the scan positions to the entire model. Thus, before the prosthesis 50 is inserted into a patient's mouth, it can be checked whether, on the one hand, the opposing bite of the prosthesis 50 is correct with the opposing jaw and, on the other hand, the position of the prosthesis 50 is also correct and flawless in relation to the implants arranged in the jaw. This ensures a problem-free and perfect fit of the prosthesis 50 in the mouth.

FIG. 9 shows a schematic representation of the individual method steps of a method for using a scan accessory system 10, as shown by way of example in FIG. 1. The scan accessory system 10 comprises a scan element 30 and a scan post 20.

In a first optional step S10, the scan post 20 is fastened in an implant, an abutment, or in an installation region 14 in a jaw or an oral cavity. S12 relates to attaching the scan element 30 to the scan post 20, preferably from the side or from above. For this purpose, the scan element 30 has a holding portion 32 that at least partially surrounds or encloses the scan post. The attachment can comprise clipping or clamping the scan element 30 to the scan post 20.

In a step S14, the scan element 30 is aligned such that a gap between the scan post 20 and an adjacent scan post 20 or an adjacent tooth is at least partially bridged. For example, the alignment of the scan element 30 can be brought about by rotating or pivoting it around the scan post 20. It can also be moved along the height direction of the scan post 20 and thus adjusted in its height on the scan post 20.

In a further optional step S16, the scan element 30 can be contacted with its free end 42 to the adjacent scan post 20 or a tooth spaced from the first scan post 20.

In a further optional step S18, the free end 42 of the scan element 30 can be fastened to the adjacent scan post 20, for example by gluing both together. The step can also alternatively comprise gluing the holding portion 32 to the scan post 20.

In an optional step S20, a digital scan is performed. This is preferably done by means of a digital scanner. For this purpose, for example, the digital scanner is moved close to the scan element 30 in such a way that the entire scan element 30 with its wing 34 and the holding portion 32 is captured. The current oral situation is also captured. The scan element 30 thus serves as a guide or steering element for the digital scanner.

In an optional step S22, the scan element 30 is released from the scan post 20. If necessary, a further release of the scan element 30 from adjacent scan posts 20 takes place. The removal of the scan element 30, for example from the oral cavity, can also be included in this step S22.

In an equally optional step S24, the scan post 20 is removed from the implant or the installation region 14. This means that the scan accessory system 10 has been completely removed, so that further treatment steps can then be carried out on the patient.

The invention has been comprehensively described and explained on the basis of the drawings and the description. The description and explanation are to be understood as an example and not as limiting. The invention is not limited to the disclosed embodiments. Other embodiments or variations arise for a person skilled in the art when using the present invention as well as upon a detailed analysis of the drawings, the disclosure, and the subsequent claims.

In the claims, the words “comprising” and “with” do not exclude the presence of other elements or steps. The indefinite article “a” or “an” does not exclude the presence of a plurality. A single element or a single unit can perform the functions of several of the units mentioned in the claims. The mere mention of some measures in several different dependent claims is not to be understood as meaning that a combination of these measures cannot also be advantageously used. Reference signs in the claims are not to be understood as limiting.

### REFERENCE NUMERICAL LIST

10 scan accessory system
12 jaw
14 installation region
20 scan post
21 bore
22 post body
24 holding region
26 contact surface
28 recess
29 post surface
30 scan element
32 holding portion
33 inside
34 wing
36 wing body
37 surface (of 36)
38 scan section
39 channel
40 positioning element
42 free end (of 34)
50 prosthesis
52 prosthesis end

1.-16. (canceled)

17. A scan element for a digital scan and for releasable fastening to a scan post fastened in an implant, an abutment, or an installation region of a jaw, comprising
a holding portion for receiving a scan post and for fastening to a scan post, the holding portion having a height in a height direction in the direction of the longitudinal extent of the scan post,
a wing adjoining the holding portion and extending at an angle of 10° to 170° with respect to the height alignment of the holding portion,
wherein
the wing at least sectionally has such a unique contour that two adjacent scanned portions in a digital scan are uniquely distinguishable and assignable.

18. The scan element according to claim 17, wherein the wing has a wing height extending in the height direction, which is at most as great as the height of the holding portion.

19. The scan element according to claim 17, wherein the wing has a surface and on its surface a plurality of positioning elements, wherein two adjacent positioning elements are different from one another and distinguishable in a scan.

20. The scan element according to claim 19, wherein the positioning elements are spaced apart from one another.

21. The scan element according to claim 19, wherein at least two of the positioning elements have a different height and/or a different cross-section.

22. The scan element according to claim 17, wherein the wing has a wing body which contour changes in the direction of a free end of the wing.

23. The scan element according to claim 22, wherein the wing has a wing body tapering in height or width.

24. The scan element according to claim 17, wherein two wings adjoin the holding portion.

25. The scan element according to claim 24, wherein the two wings are arranged opposite one another.

26. The scan element according to claim 24, wherein the two wings are enclosing an angle between 120° and 180°.

27. The scan element according to claim 24, wherein the two wings have different lengths.

28. The scan element according to claim 24, wherein the two wings have the same or substantially the same width.

29. The scan element according to claim 17, wherein the scan element consists of a non-toxic material detectable by a digital scanner.

30. The scan element according to claim 29, wherein the scan element consists of plastic or metal.

31. The scan element according to claim 17, wherein the scan element has a surface such that detection of the scan element in a digital scan occurs with a negligible error rate in practical use.

32. The scan element according to claim 17, wherein the holding portion has a lateral opening and the holding portion being formed as a claw or a clamp, and such that the scan post can be received through the opening.

33. A scan accessory system for digitally scanning a dental situation in a patient's mouth, comprising
a scan post for fastening to an implant, an abutment, or an installation region of a jaw, and
a scan element for releasable fastening to the scan post,
wherein
the scan post has a post body extending in the longitudinal direction, which has a holding region with a contact surface for contacting the scan element,
the scan element has a holding portion for receiving and fastening to a scan post, the holding portion having a height in a height direction in the direction of longitudinal extent of the scan post,
the scan element has a wing adjoining the holding portion and extending at an angle of 10° to 170° with respect to the height direction of the holding portion,
wherein
the wing at least sectionally has such a unique contour that two adjacent scanned portions in a digital scan are uniquely distinguishable and assignable,
the holding region is configured such that the scan element can be fastened to the scan post in the height direction at any position and its height can be continuously adjusted in the longitudinal extent of the scan post.

34. The scan accessory system according to claim 33, wherein the wing has a wing height extending in the height direction, which is at most as great as a height of the holding portion.

35. The scan accessory system according to claim 33, wherein the scan element can be arranged on the scan post positioned in a patient's mouth in such a way that the scan element is spaced apart from the patient's gingiva.

36. The scan accessory system according to claim 33, wherein the scan element can be fastened to the scan post such that it can pivot around the scan post.

37. The scan accessory system according to claim 36, wherein the scan element can pivot at an angle of at least 90°.

38. The scan accessory system according to claim 36, wherein the scan element can pivot at an angle of at least 180°.

39. The scan accessory system according to claim 33, wherein several scan posts are placed in a patient's mouth and at least one of the scan posts carries a scan element, the scan element being connected to one of the other scan posts.

40. A method of using a scan accessory system according to claim 33 with a scan element and a scan post, characterized by the following steps:
fastening the scan post in an implant or an installation region in an oral cavity;
attaching the scan element to the scan post from the side or from above;
aligning the scan element such that a gap between the scan post and an adjacent scan post or tooth is at least partially bridged;
contacting the scan element with its free end to the adjacent scan post or tooth;
fastening or bonding the free end of the scan element to the adjacent scan post;
carrying out a digital scan by means of a digital scanner;
releasing the scan element and removing it from the oral cavity;
removing the scan post from the implant or the installation region.
